(19) United States
(12) Patent Application Publication
(10) Pub. No.: US 2002/0097638 A1
(43) Pub. Date: Jul. 25, 2002

(54) Setting structure of electronic timer

(75) Inventor: Albert Stekelenburg, Taipei (TW)

Correspondence Address: DOUGHERTY & TROXELL, SUITE 1404, 5205 LEESBURG PIKE, FALLS CHURCH, VA, 22041, US

(73) Assignee: All -Time Inc

(21) Appl. No.: 09/767,877

(22) Filed: Jan. 24, 2001

(51) Int. Cl. G04F 8/00

(52) U.S. Cl. 368/107

(57) ABSTRACT

A setting structure of electronic timer, its constitution includes a main body and a reveal able faceplate, a LED display is provided on the faceplate, a recess is provided on the main body there under, several keys are provided in the recess; setting position is via faceplate displayed by means of controlling and operating the keys; a projection is further provided under the faceplate, and a key is provided on main body of a relative position with the projection, the key can be indirectly depressed by depressing faceplate in order to achieve a function ON/OFF therein; a structure of timer with larger displaying faceplate and wider interval between keys is achieved by above-mentioned structure.

### FIELD AND BACKGROUND OF THE INVENTION

The present application relates to a setting structure of time period setting device for timer, denotes especially a setting structure of electronic timer.

As shown in FIG. 1 is presently a conventional structure of electronic timer in market, its constitution includes further a time period setting part (including time display), the part includes at least a LED displaying faceplate C and several keys D, the displaying faceplate and keys are therefore very small, because the displaying faceplate and key must be harmonically provided on a limited and usable area, and erroneous setting is also easily formed for the man whose eyesight and controlling are not good, especially, the mistakes of setting are further easily produced when the light is bad.

### SUMMARY OF THE INVENTION

The object of the present application is to provide a setting structure of electronic timer, which makes displaying faceplate and interval between keys larger, and is favorable for operation and setting.

Implementing above-mentioned object of present application adopts technical solution as below: its constitution includes a main body and a reveal able faceplate, the main body includes a power input plug and a power output, a reveal able faceplate is provided above main body, a recess is provided on main body under faceplate, several keys are provided in the recess; main body is a plat-like body structure, provided above main body and in the form of reveal able structure, a displaying faceplate is provided above faceplate, a LED display is provided in inner of faceplate, and is via bus connected to the inner of main body; a reveal able faceplate is provided on the main body, keys for setting are provided on the recess of main body under the reveal able faceplate, which forms a timer structure with larger faceplate and larger interval between keys; the structure provides further with a projection on the back of faceplate, the projection is respective to a key, a pre-set ON/OFF function of circuit is produced by means of depressing the faceplate downwards.

### BRIEF DESCRIPTION OF THE DRAWINGS

FIG. 1 is a perspective view of conventional timer;

FIG. 2 is a perspective view (I) of timer of present application;

FIG. 3 is a perspective view (II) of timer of present application, (faceplate is in the position of revelation);

FIG. 4 is a perspective view of the back of faceplate;

FIG. 5 is a perspective view of the recess stand,

FIG. 6 is a partial sectional view of the present application.

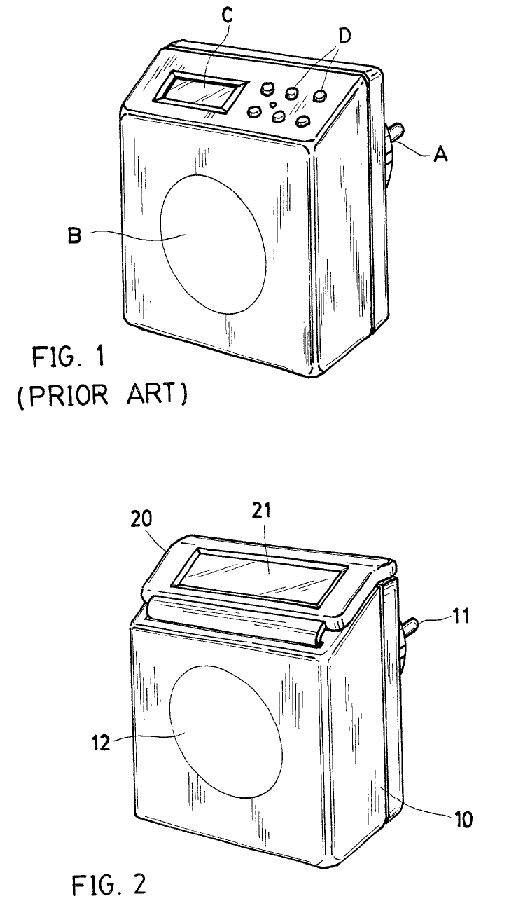

### DETAILED DESCRIPTION OF A PREFERRED EMBODIMENT

As shown in FIG. 2, the constitution of present application includes a main body 10, a faceplate 20. The constitution of main body 10 includes a power input plug 11, a power output 12, a reveal able faceplate 20 is provided above main body 10, displaying faceplate is provided on the faceplate 20.

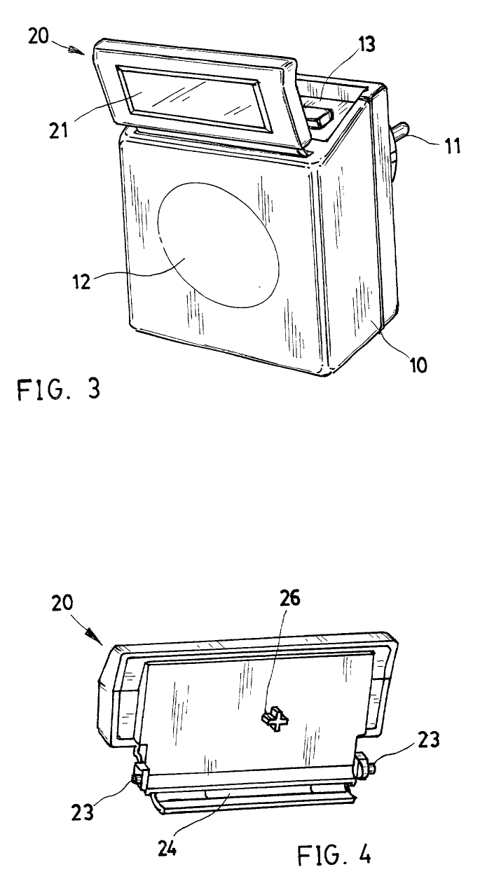

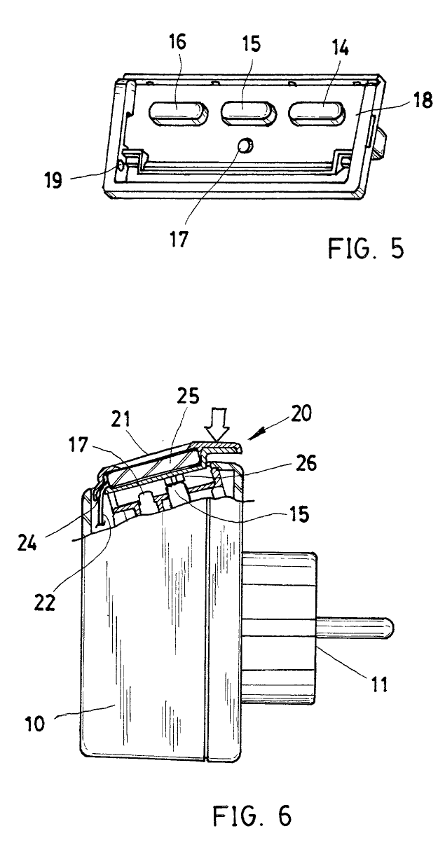

As shown in FIG. 3, the faceplate 20 is in revealing position, the displaying faceplate 21 is located in a position in which it's easily seen; a recess 13 is provided above main body 10 (i.e. under the faceplate which is not revealed), several keys are provided in the recess 13 (please reference to FIG. 5), these keys 14, 15, 16 and resent key etc are provided on a recess stand 18; the function and its related circuit of these keys 14, 15, 16 are as same or as analogical as the setting structure of conventional timer, all of which are no longer described because which are not in the claimed scope.

Shown in FIGS. 4, 5 are respectively perspective view of faceplate 20 and recess stand 18, FIG. 6 is upper partial sectional view of embodiment of present application; the faceplate 20 is via bus connected with circuit of main body 10, a pair of rotary axle 23 and a bus-hole 24 are provided on one side of faceplate 20, the rotary axles 23 are mated with the axle-hole of side of recess stand 18 each other, the faceplate 20 can be revealed or not revealed at the rotary axle 23; bus 22 introduced from the main body 10 is through bus-hole 24 passed, the bus 22 is connected to LED display 25; a projection 26 is provided on the inner side of faceplate 20, the projection 26 is just against the top of key 15 therein, when the faceplate 20 is put down (not in position of revelation), the key 15 is depressed and a pre-set function of circuit ON/OFF is produced when the faceplate 20 is depressed (reference to FIG. 6).

In summary, the present application provides with a reveal able faceplate 20, a displaying faceplate 21 of LED display, which is larger than the conventional, is provided on the faceplate 20, the interval between key 14, 15, 16 and reset key etc on the main body 10 is larger, as compared with conventional structure, a larger displaying faceplate 21 and larger interval between keys is achieved by present application, which is indeed a timer structure with improved effect.

In practice, due to that the specification of plug and socket in each country is various, the plug and socket as explaining in present application are expressed with block mode, which are not limited by the shown structure:

1. A setting structure of electronic timer, its constitution includes a main body and a recallable faceplate,
the main body includes a power input plug and a power output, a reveal Abe faceplate is provided above main body, a recess is provided on the main body under the faceplate, several keys are provided in the recess;
the faceplate is a plate-like body structure, provided above the main body and in the form of reveal able structure, a displaying faceplate is provided above the faceplate, a LED display is provided in the inner of faceplate and is via bus connected to the inner of main body;
characterized in that, a reveal able faceplate is provided on the main body, keys for setting are provided on the recess of main body under the reveal able faceplate, which forms a timer structure with larger faceplate and larger interval between keys.

2. The setting structure of electronic timer according to claim 1, characterized in that, the structure provides further with a projection in the back of faceplate, the projection is respective to a key, a pre-set ON/OFF function of circuit is produced by means of depressing the faceplate downwards.
